(19) United States
(12) Patent Application Publication
(10) Pub. No.: US 2018/0242534 A1
(43) Pub. Date: Aug. 30, 2018

(54) RAISED BED GARDEN ASSEMBLY

(71) Applicants: John Herridge, San Diego, CA (US); Richard Gieseke, Tomball, TX (US)

(72) Inventors: John Herridge, San Diego, CA (US); Richard Gieseke, Tomball, TX (US)

(21) Appl. No.: 15/445,824

(22) Filed: Feb. 28, 2017

(51) Int. Cl. A01G 9/02; A01G 9/12; A01G 1/00; A01G 7/00; A01G 27/00; A01G 13/10

(52) U.S. Cl. CPC A01G 9/025; A01G 9/12; A01G 1/001; A01G 9/028; A01G 27/00; A01G 13/10; A01G 7/00

(57) ABSTRACT

A raised bed planter box includes a first corner post, a second corner post, a third corner post, and a fourth corner post. Each of the corner posts defines a first open-ended channel and a second open-ended channel positioned at an angle of about 90 degrees relative to the first open-ended channel. A first sidewall extends between the first open-ended channel of the first corner post and the first open-ended channel of the second corner post. A first end wall extends between the second open-ended channel of the second corner post and the second open-ended channel of the third corner post. A second sidewall extends between the first open-ended channel of the third corner post and the first open-ended channel of the fourth corner post. A second end wall extends between the second open-ended channel of the fourth corner post and the second open-ended channel of the first corner post.

### FIELD OF THE INVENTION

The present invention is related to the field of gardening, particularly to raised garden beds and planter boxes.

### BACKGROUND

Raised bed gardens elevate produce, flowers, and/or other plants above the ground. The higher the raised bed gardens are above a ground surface, the greater the forces on the sidewalls are from the contents disposed therein (e.g., soil and the like,). Typically to counteract these higher forces, external reinforcements (e.g., stakes, poles, and the like,) and/or more heavy duty materials are used, in combination with various mechanical fasteners. Such solutions are expensive, time consuming, and difficult to be implemented by an ordinary person.

### SUMMARY

According to an exemplary embodiment, raised garden bed assemblies are provided including various components that facilitate a light weight and cost effective garden assembly of an appropriate predetermined height (such as, for example, waist high to one of ordinary stature) that may be assembled without the use of any mechanical fasteners, and may be built easily by one person with essentially no special tools.

In one embodiment, the raised bed garden assembly includes (i) a pair of raised bed planter boxes which may be, for example, waist high to one of ordinary stature, and (ii) an overhead arch support structure extending therebetween.

In one embodiment, the raised bed garden assembly includes (i) a single planter box which may be, for example, waist high to one of ordinary stature, and (ii) an overhead arch support structure having one end disposed within the planter box and an opposing second end secured to a wall or a ground surface.

In one embodiment, the raised bed garden assembly does not include an overhead arch support structure. The planter box which may be, for example, waist high to one of ordinary stature, and may be used alone or in combination with a support structure extending vertically therefrom.

In one embodiment, the raised bed garden assembly includes (i) three or more planter boxes which may be, for example, waist high to one of ordinary stature, and (ii) two or more overhead arch support structures such as, for example, one overhead arch support structure for every adjacent pair of planter boxes.

In one embodiment, the raised bed planter box includes a plurality of corner posts, a first sidewall, a first end wall, a second sidewall, and a second end wall. The plurality of corner posts include a first corner post, a second corner post, a third corner post, and a fourth corner post. Each of the plurality of corner posts defines a first open-ended channel and a second open-ended channel positioned at an angle of about 90 degrees relative to the first open-ended channel. The first sidewall extends between the first open-ended channel of the first corner post and the first open-ended channel of the second corner post. The first end wall extends between the second open-ended channel of the second corner post and the second open-ended channel of the third corner post. The second sidewall extends between the first open-ended channel of the third corner post and the first open-ended channel of the fourth corner post. The second end wall extends between the second open-ended channel of the fourth corner post and the second open-ended channel of the first corner post. The first sidewall, the second sidewall, the first end wall, and the second end wall cooperatively define an internal cavity of the raised bed planter box.

In one embodiment the raised bed garden assembly includes a first planter box having a predetermined height, a second planter box having the predetermined height and spaced a predetermined distance from the first planter box, and a wire grid panel having a length that extends between the first planter box and the second planter box forming an overhead arch support structure. Each of the first planter box and the second planter box includes a first end wall, a second end wall, a first sidewall defining a first slot at a target height above a ground surface, and a second sidewall defining a second slot at the target height above the ground surface. The first end wall, the second end wall, the first sidewall, and the second sidewall cooperatively define an internal cavity. The raised bed garden assembly additionally includes a support shelf disposed within the internal cavity and received by the first slot and the second slot such that the support shelf extends laterally between the first sidewall and the second sidewall.

In one embodiment, the raised bed planter box includes a first end wall, a second end wall, a first sidewall defining a first recess at a target height above a ground surface, a second sidewall defining a second recess at the target height above the ground surface, and a plurality of corner posts configured to couple the first end wall, the second end wall, the first sidewall, and the second sidewall together such that the first end wall, the second end wall, the first sidewall, and the second sidewall cooperatively define an internal cavity. According to an exemplary embodiment, each of the plurality of corner posts defines a first channel and a second channel positioned at an angle of 90 degrees relative to the first channel. The raised bed planter box additionally includes a support shelf configured to be disposed within the internal cavity and received by the first recess and the second recess such that the support shelf extends laterally between the first sidewall and the second sidewall at the target height and separates the internal cavity into an upper cavity and a lower cavity.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The drawings are provided to illustrate example embodiments described herein and are not intended to limit the scope of the disclosure. Throughout the drawings, reference numbers may be re-used to indicate general correspondence between referenced elements.

FIGS. 1A-1C are various views of vertical plant support structures, according to various embodiments;

FIG. 2 is a perspective view of a raised bed garden assembly having a pair of raised bed planter boxes and a wire grid forming an overhead arch support structure, according to an exemplary embodiment;

FIG. 3 is front view of the raised bed garden assembly of FIG. 2, according to an exemplary embodiment;

FIG. 4 is a partial cross-sectional perspective view of the raised bed planter box of FIG. 2, according to an exemplary embodiment;

FIG. 5 is a perspective view of a side board of a sidewall of the raised bed planter box of FIG. 4, according to an exemplary embodiment;

FIG. 6 is a perspective view of a side board of a sidewall of the raised bed planter box of FIG. 4 defining a recess, according to an exemplary embodiment;

FIG. 7 is a perspective view of an end board of an end wall of the raised bed planter box of FIG. 4, according to an exemplary embodiment;

FIG. 8 is a perspective view of a lateral board of a support shelf of the raised bed planter box of FIG. 4, according to an exemplary embodiment;

FIG. 9 is a perspective view of a corner post of the raised bed planter box of FIG. 4, according to an exemplary embodiment;

FIG. 10 is a perspective view of an intermediate post that interconnects adjacent raised bed planter boxes, according to an exemplary embodiment; and

FIG. 11 is a perspective view of a raised bed garden assembly having a raised bed planter box and a wire grid forming a vertical support structure, according to an exemplary embodiment.

### DETAILED DESCRIPTION

Various aspects of the disclosure will now be described with regard to certain examples and embodiments, which are intended to illustrate but not to limit the disclosure. Nothing in this disclosure is intended to imply that any particular feature or characteristic of the disclosed embodiments is essential. The scope of protection is defined by the claims that follow this description and not by any particular embodiment described herein. Before turning to the figures, which illustrate example embodiments in detail, it should be understood that the application is not limited to the details or methodology set forth in the description or illustrated in the figures. It should also be understood that the terminology is for the purpose of description only and should not be regarded as limiting.

According to an exemplary embodiment, raised garden bed assemblies are provided including one or more planter beds or boxes of an appropriate height (e.g., waist high to one of ordinary stature, etc.) to provide an optimum height for ease of work and accessibility to a particular user, as well as pest prevention. The raised garden bed assemblies may be further configured to facilitate the use of either or both of (i) a layer of rocks and/or an elevating shelf and (ii) an adequate soil depth. As would be appreciated by the present disclosure, while the height of a planter bed or box in accordance with the teachings of the present invention may be waist high to one of ordinary stature, the height may be modified to accommodate the height of all statures in order to provide ease of work to a particular user of particular stature. Similarly, the height of one or more planter boxes may be configured to accommodate a wheel chair or similar conveyance.

Backyard gardening has been part of our society ever since we moved off the farms of our agrarian past, and into urban settings and suburban homes. At times, there have been national emergencies that have promoted urban gardening, most notably during World War II, when Victory Gardens sprung up across the country. In post-war years, farms have become larger and more automated. Smaller farms have frequently disappeared because they are unable to compete. The system of food delivery relies on a highly developed, rapid transportation system, the advent of refrigeration, cheap oil, and almost instant communication with moving trucks. This “Just-In-Time” system now in use allows for turnover of produce in our retail stores every three days. The heavy reliance on this system has exposed certain inherent shortcomings. Urban gardening offers a return to basic principles of food production.

In many regions of the world, urban gardening provides a significant part of the food supply. In dense urban areas, front yards, backyards, side yards, rooftops, and other small spaces may be used to grow vegetables. The United States has historically lagged behind the rest of the world in these efforts. Due to our affluence and culture, a substantive growth of urban gardening in the U.S. may only occur if a simple, economical, space efficient, and low labor intensive garden structure is provided.

A growing percentage of the population is drawn to home gardening. People increasingly want more nutritious produce, more security from interruptions caused by natural and economic disasters, the cost savings of growing your own produce, a more environmentally friendly food source, and the personal enjoyment of creating a small garden. Unfortunately, these worthy objectives are often confronted by the harsh realities of making a small garden productive. Soil quality varies greatly, animals and pests eat healthy young plants, insects and fungi kill the plants if proper conditions are not managed, weeds multiply, and general knowledge of gardening is lacking. Amateur gardeners may become discouraged after they have repeatedly crawled around on their hands and knees to cultivate, prune, and pick weeds and the plants still die and/or are eaten by pests. The raised bed garden assembly of the present disclosure is configured to provide various new and useful improvements to home garden construction to eliminate or lessen the factors that may typically cause a home garden to be unproductive by overcoming the deficiencies in prior home gardens structures, particularly in the area of raised bed gardening and vertical vegetation support structures.

Raised bed gardening is a form of gardening in which a planting media (e.g., soil and the like) is contained in an above-ground box. The above-ground box may have a width such that a person is able reach the middle from either side, and may have any length suitable for the available space. These above-ground boxes may be typically made from lumber, railroad ties, polymer planks, concrete blocks, and/or rocks. Raised bed gardens may provide various advantages relative to non-raised bed gardens including, but not limited to: (i) facilitating the control of the growing media (e.g., because soil mixtures and additives can be formulated by the gardener to promote plant growth, especially in areas where poor native soil exists, and the like, (ii) producing higher yields because of the vegetable plants being spaced closer together relative to conventional row gardening, (iii) conserving water because of the high plant density, (iv) preventing a gardener from having to walk on the planting media such that the planting media does not become compacted and the roots of the plants have an easier time growing, (v) extending the planting season (e.g., in response to the above-ground planting media warming more quickly in the spring than ground soil, and the like), and/or (vi) maintaining the vegetation out of the reach of animals (e.g., vermin, rats, mice, gophers, rabbits, and the like).

Often, the bed height of raised gardens are knee high or less (e.g., less than two feet high, and the like). At these low heights, many of the aforementioned benefits are marginalized. Further, at knee high heights or less, a person must bend or stoop to perform various gardening tasks (e.g., which may be uncomfortable, difficult, etc. for many people). According to an exemplary embodiment, the raised bed garden of the present disclosure is waist high or approximately waist high (e.g., greater than two feet, between two feet and four feet high, and the like). A waist high garden may facilitate a gardener in performing various gardening tasks without needing to bend over, kneel, or stoop down. The use of some sort of vertical plant support structure rising out of the bed may further enhance certain positive attributes of a raised bed, particularly plant density and garden productivity. A waist high planter box, when used as the platform for an overhead, arched plant support structure, provides the latest advancements in urban gardening.

However, as bed height increases, the volume of planting media increases. The increased volume of the planting media, especially when wet, generates high lateral outward forces on the sidewalls of the raised bed box. In many instances it is desirable to use thin walled construction boards or other lightweight materials for raised bed boxes, as these materials are often relatively inexpensive, and lighter to ship and handle. However, as the load increases from the forces of increasing volume of the planting media, the lateral forces distort the planter box sidewalls because the boards simply do not have the flexural strength to resist the deformation. The sidewalls may thereby rapidly distort and fail. Traditionally, additional supports may be added to the raised bed boxes to overcome the increased forces. For example, vertical reinforcing posts may be anchored, preferably with cement, into the ground, and spaced uniformly along the walls of the box to support the sidewalls against the increased stresses. However, such reinforcement may be time consuming and expensive. As another example, mechanical fasteners (e.g., hinges, flanges, brackets, clamps, ties, dowels, screws, nails, and the like) may additionally or alternatively be used when constructing a raised bed box. Another approach is to use thicker boards, like railroad ties or thick landscape timbers, which, when stabilized with vertical spikes, may last a long time. However, railroad ties are expensive, hard to handle, and may leach creosote and other harmful chemicals into the soil. Also, landscape timbers are quite expensive and require the use of mechanical fasteners. According to an exemplary embodiment, the waist high planter box of the present disclosure provides an economical and a simple method for retaining sidewalls made of thin-walled structural members without using posts affixed in the ground or the use of mechanical fasteners.

The following U.S. patents disclose elevated boxes that use mechanical fasteners such as hinges, flanges, brackets, clamps, ties, dowels, fasteners, and the like at the ends of structural wall members forming corners to hold the structural walls together: U.S. Pat. Nos. 619,352; 2,332,652; and 4,363,189. U.S. Pat. No. 4,869,018 discloses a raised bed formed by a plurality of raised wall members. The wall members are hollow to provide irrigation. These hollow, plastic wall members cannot be made into a bed of any significant height (e.g., waist high, and the like), as the wall members will deform and fail as a result of the lateral soil forces. U.S. Pat. No. 5,400,544 discloses a raised bed that uses a horizontal trellis or internal membrane to hold growing media above the ground, but no lateral reinforcement is provided by the system of slots, projections, and ledges. If a waist high box of soil were made using these plastic wall members, the boxes would bulge and fail. U.S. Pat. No. 7,424,787 discloses a modular knee high planter box joined at corners by special brackets, hinges, and flanges, but, again, these boxes have no internal reinforcement against lateral forces, other than the flex properties of the wall members themselves. Accordingly, a waist high planter box is not possible with this invention, unless much thicker, and therefore uneconomical, wall members are used.

Raised planter boxes inhibit rabbits and other above-ground animals from entering the beds. The higher the sidewalls, the more the protection. Gophers are another matter altogether. Since they enter the beds via underground tunnels and through the bottom of the bed, neither a fence nor a sidewall keeps them out. U.S. Pat. No. 7,424,787 mentions a mesh of poultry wire or hardware cloth, to prevent or retard the entrance of gophers. An aggressive gopher will eat through such thin mesh materials. A possible deterrent is a layer of rocks, large stones, or even thick stoneware; or elevation of the bed from the ground surface with a shelf. Knee high raised bed gardens, however, do not provide enough planter box height for (i) a layer of rocks and/or an elevating shelf and (ii) at the same time a bed of soil deep enough for effective root growth.

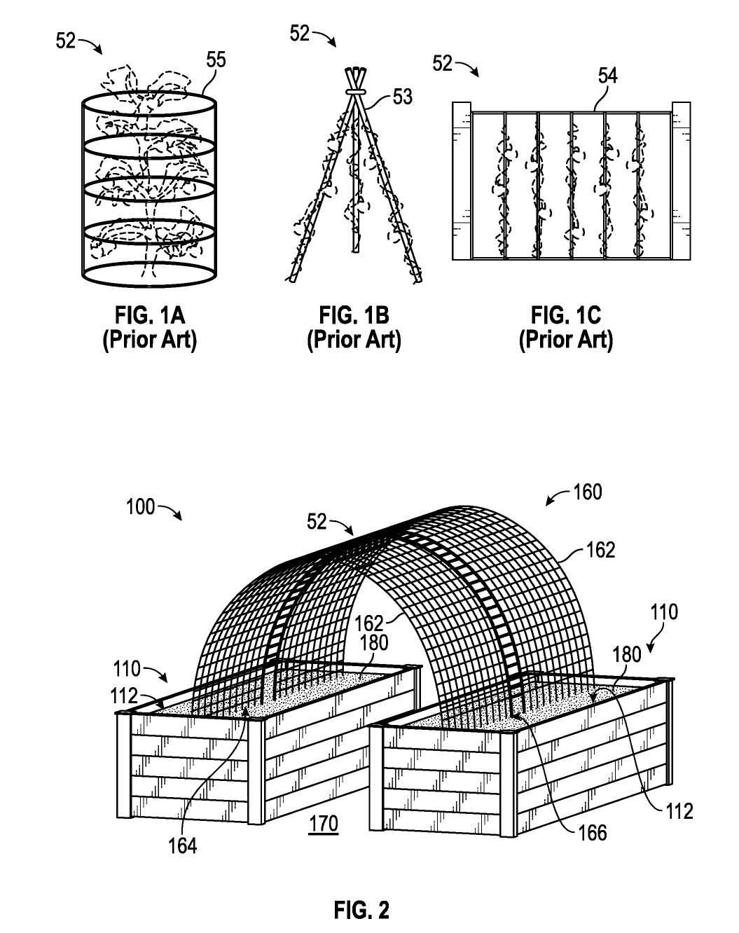

According to some embodiments, a raised garden bed or box in accordance with the teachings of the present invention, may include a vertical support structure, such as a trellis, a lattice, a garden hoop, a cage, strings, nets, and/or vertical stakes. For example, as shown in FIGS. 1A-1C, various gardening support structures, shown as vertical support structures 52, traditionally in the form of a triangular support structure 53, a vertical planar support structure 54, a cylindrical support structure 55, and the like, are usable with gardening. Vertical support structures 52 may provide various advantages when gardening including increasing productivity by facilitating vertical growth from a small patch of growing area. A vine that is attached to a vertical support structure 52 may use energy for leaf and produce growth, rather than investing that energy to make supportive stem tissue. Vine and sprawling plants, such as cucumbers, tomatoes, melons, peas, squash, and pole beans are candidates for this type of gardening. Some plants do not climb naturally, but may be trained to do so, if a vertical support structure 52 is provided that the vines can be affixed to. Vertical gardening takes advantage of tropism, which is a biological phenomenon indicating growth or motility of a biological organism, usually a plant, in response to an environmental stimulus. Tropisms are usually named for the stimulus involved (for example, a phototropism is a reaction to light) and may be either positive (towards the stimulus) or negative (away from the stimulus). In a garden application, the support structure takes advantage of positive phototropism. As the vines, which are attached to a vertical support, climb more quickly toward the sunlight, growth is maximized, and hence, so is vegetable productivity.

Typically, to make a more permanent arch structure rigid metal members are used that are joined together through a welding process. An arch shape, although usually not a true parabolic shape, is often used for floral arbors with climbing vegetation, and they usually are made by welding many separate, rigid pieces. The main attribute of a rigid arch is that the vegetation can grow higher and directly overhead, allowing persons to walk under and through it, creating a very decorative backyard feature. The drawbacks are that it is heavy, must be welded, usually off site, and if so, it is difficult to transport. Given all of this, such rigid arch systems are quite expensive and not useful for an economical backyard garden. Sometimes, a combination of vertical and horizontal planar spans, making a three dimensional structure, are used. Vine plants may grow up and over these support structures, effectively increasing productivity of any horizontal garden bed. A plurality of members, made from wood, metal, or plastic materials, are first formed into tubes, hooks, rods, and the like, and then assembled into some type of support structure. The members are then fastened together by use of copious nails, screws, flexible wire, solvent welding, hinges, rope, crimps, and/or other mechanical fasteners. This numerous-step assembly process is cost ineffective in terms of time and materials.

U.S. Pat. No. 1,336,580 discloses an expandable, semi-rigid trellis, which, when clamped to pointed anchor stakes secured into the ground, can be formed into an arch. In this application, plastic deformation would be probable, so the trellis could not be collapsed to its original shape. Further, it would be tedious to assemble, with many clamps and fasteners. U.S. Pat. No. 6,907,694 discloses a trellis support structure for supporting vine borne crops. Upon examination, this invention shows a two dimensional, U-shaped arm attached to a post, with the entire assembly affixed into the growing media. This is not, then, a structural arch. U.S. Pat. No. 4,751,792 discloses sidewall brackets for attaching vertical support members that rise above a garden bed, but these are planar, as in an “A” frame, or with curvature, by bending a single plastic member from bracket to bracket. It would take a lot of brackets and a lot of cross members with mechanical attachments to create a vine growing arch using this system. Again, all of these prior art systems require mechanical attachment of many members and mechanical anchoring using brackets, clamps, ground spikes, mechanical fasteners, and the like.

Accordingly, a need persists for a waist high garden bed with reinforced sidewalls, made from inexpensive materials, with an easily assembled and inexpensive vertical plant support structure, all of which allows for ease of work, pest and weed resistance, and ultimately, productive results. According to an exemplary embodiment, the waist high raised bed garden assembly of the present disclosure includes a flexible perforate wire grid which arises out of waist high planter beds, making a sturdy, overhead parabolic arch and plant support, while requiring no means of anchoring, other than being buried in the planting media.

### Raised Bed Garden Assembly

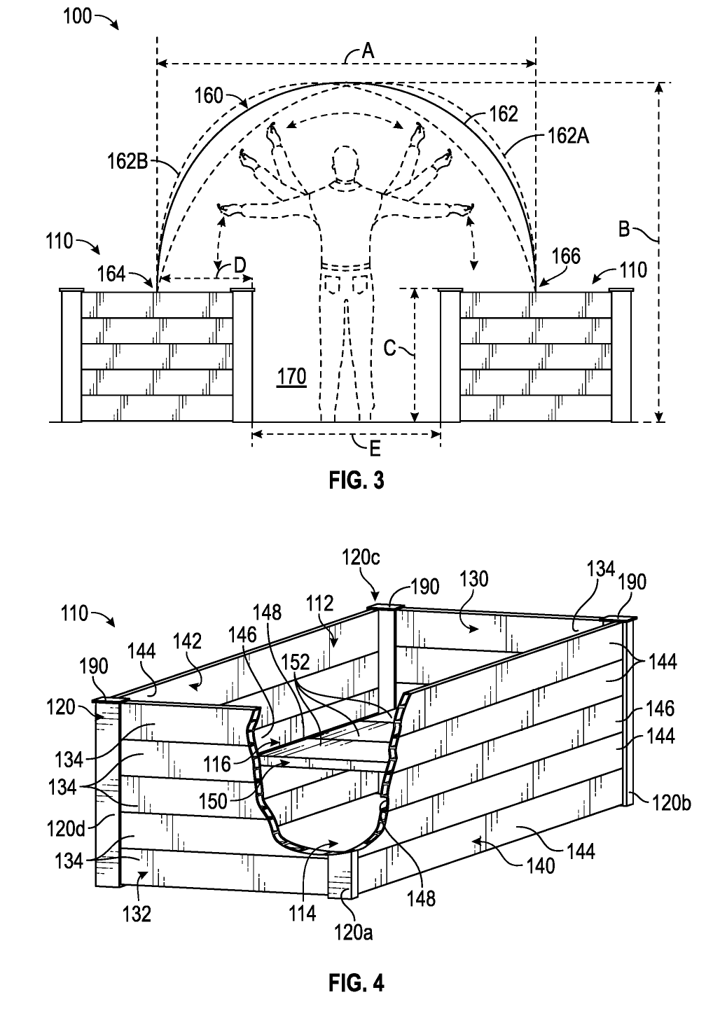

According to the exemplary embodiment shown in FIGS. 2-10, a garden assembly, shown as raised bed garden assembly 100, includes various components that facilitate providing a light weight, waist high, and cost effective garden assembly that may be assembled without the use of any mechanical fasteners, and may be built easily by one person with essentially no special tools (e.g., the raised bed garden assembly 100 facilitates toolless construction, etc.). As shown in FIGS. 2 and 3, the raised bed garden assembly 100 includes a pair of raised bed planter boxes, shown as waist high planter boxes 110, and a support structure 52 formed as an arch support structure, shown as overhead arch support structure 160, extending therebetween. In other embodiments, the raised bed garden assembly 100 includes a single waist high planter box 110 and the overhead arch support structure 160 having one end disposed within the single waist high planter box 110 and an opposing second end secured to a wall or a ground surface. In still other embodiments, the raised bed garden assembly 100 does not include the overhead arch support structure 160. In such embodiments, the waist high planter box 110 may be used alone or in combination with a vertical support structure (e.g., see FIG. 11). In yet other embodiments, the raised bed garden assembly 100 includes three or more waist high planter boxes 110 and two or more overhead arch support structures 160 (e.g., one overhead arch support structure 160 for every adjacent set of waist high planter boxes 110, and the like).

### Waist High Planter Box

As described above, while the height of a planter bed or box in accordance with the teachings of the present disclosure may be waist high to one of ordinary stature, the height thereof may be modified to accommodate the height of all statures, a wheel chair, or similar height accommodations, in order to provide ease of work to a particular user. Accordingly, reference to “waist high” is intended to encompass such height variations.

In particular, as shown in FIG. 4, each of the waist high planter boxes 110 includes a plurality of corner posts, shown as corner posts 120; a first end wall, shown as first end wall 130; an opposing second end wall, shown as second end wall 132; a first sidewall, shown as first sidewall 140; an opposing second sidewall, shown as second sidewall 142; an internal shelf, shown as support shelf 150; and a plurality of caps, shown as end caps 190. According to the exemplary embodiment shown in FIG. 4, the waist high planter box 110 includes a first corner post 120a, a second corner post 120b, a third corner post 120c, and a fourth corner post 120d positioned to couple the first end wall 130, the second end wall 132, the first sidewall 140, and the second sidewall 142 together such that the first end wall 130, the second end wall 132, the first sidewall 140, and the second sidewall 142 cooperatively form a rectangular shape and define an internal cavity, shown as internal cavity 112. In other embodiments, the waist high planter box 110 includes a different number of corner posts 120 (e.g., three, six, eight, etc.) and a corresponding number of sidewalls and/or end walls such that the waist high planter box 110 has another shape (e.g., triangular, hexagonal, octagonal, and the like).

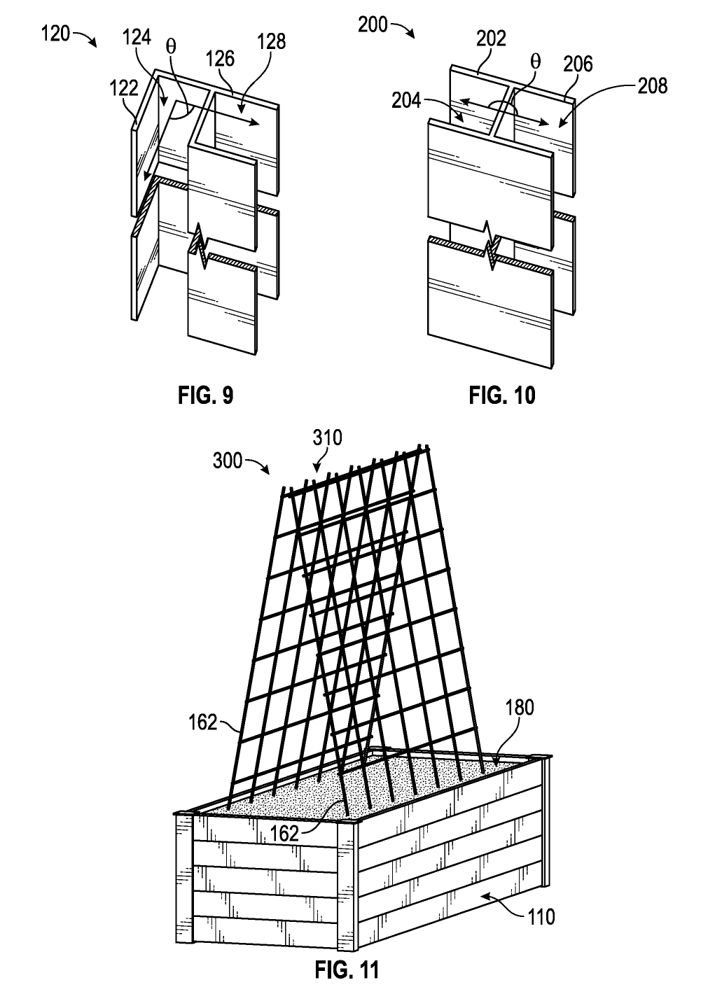

As shown in FIG. 9, each of the corner posts 120 includes a first portion, shown as first flange 122, defining a first open-ended channel, shown as first channel 124, and a second portion, shown as second flange 126, defining a second open-ended channel, shown as second channel 128, positioned at an angle θ relative to the first channel 124. As shown in FIG. 9, the first flange 122 and the second flange 126 share at least one wall (e.g., a sidewall of the first flange 122 and the back wall of the second flange 126 are one wall, and the like). According to the exemplary embodiment shown in FIG. 9, the angle θ is 90 degrees such that the waist high planter box 110 has a rectangular or square shape. In other embodiments, the angle θ is greater than or less than 90 degrees. By way of example, the waist high planter box 110 may have a triangular shape such that the angle θ between the first channel 124 and the second channel 128 of at least some of the corner posts 120 is less than 90 degrees. As an example, the waist high planter box 110 may include three corner posts 120, each corner post 120 having the first channel 124 at an angle of 60 degrees relative to the second channel 128 (e.g., such that the waist high planter box 110 has an equilateral triangle shape, and the like). As another example, the waist high planter box 110 may include three corner posts 120, one corner post 120 having the first channel 124 at an angle of 90 degrees relative to the second channel 128 and the other two corner posts 120 having the first channel 124 at an angle of 45 degrees relative to the second channel 128 (e.g., such that the waist high planter box 110 has an isosceles right triangle shape, and the like). As yet another example, the waist high planter box 110 may include three corner posts 120, a first corner post 120 having the first channel 124 at an angle of 90 degrees relative to the second channel 128, a second corner post 120 having the first channel 124 at an angle of 60 degrees relative to the second channel 128, and a third corner post 120 having the first channel 124 at an angle of 30 degrees relative to the second channel 128 (e.g., such that the waist high planter box 110 has a 30-60-90 triangle shape, and the like).

By way of another example, the waist high planter box 110 may have a n-polygon shape having more than four sides such that the angle θ between the first channel 124 and the second channel 128 of each corner post is greater than 90 degrees. As an example, the waist high planter box 110 may include six corner posts 120, each corner post 120 having the first channel 124 at an angle of 120 degrees relative to the second channel 128 (e.g., such that the waist high planter box 110 has an hexagonal shape, and the like). As another example, the waist high planter box 110 may include eight corner posts 120, each corner post 120 having the first channel 124 at an angle of 135 degrees relative to the second channel 128 (e.g., such that the waist high planter box 110 has an octagonal shape, and the like).

According to an exemplary embodiment, a first end of the first sidewall 140 is slidably received by the first channel 124 of the first corner post 120a and an opposing second end of the first sidewall 140 is slidably received by the first channel 124 of the second corner post 120b such that the first sidewall 140 extends between the first corner post 120a and the second corner post 120b. According to an exemplary embodiment, a first end of the first end wall 130 is slidably received by the second channel 128 of the second corner post 120b and an opposing second end of the first end wall 130 is slidably received by the second channel 128 of the third corner post 120c such that the first end wall 130 extends between the second corner post 120b and the third corner post 120c. According to an exemplary embodiment, a first end of the second sidewall 142 is slidably received by the first channel 124 of the third corner post 120c and an opposing second end of the second sidewall 142 is slidably received by the first channel 124 of the fourth corner post 120d such that the second sidewall 142 extends between the third corner post 120c and the fourth corner post 120d. According to an exemplary embodiment, a first end of the second end wall 132 is slidably received by the second channel 128 of the fourth corner post 120d and an opposing second end of the second end wall 132 is slidably received by the second channel 128 of the first corner post 120a such that the second end wall 132 extends between the fourth corner post 120d and the first corner post 120a.

As shown in FIG. 4, the first sidewall 140 defines a first recess and the second sidewall 142 defines a corresponding second recess, shown as shelf slots 148, that extend along a longitudinal length of each of the first sidewall 140 and the second sidewall 142 at a target height above a ground surface (e.g., 10, 12, 14, 16, 18, 20, and the like, inches). As shown in FIG. 4, the support shelf 150 is configured to be disposed within the internal cavity 112 of the waist high planter box 110 and slidably received by the shelf slots 148 such that the support shelf 150 extends laterally between the first sidewall 140 and the second sidewall 142 at the target height. In some embodiments, the first end wall 130 and the second end wall 132 additionally or alternatively define the shelf slots 148 such that the support shelf 150 extends longitudinally between the first end wall 130 and the second end wall 132 at the target height. As shown in FIG. 4, the support shelf 150 separates the internal cavity 112 into a first cavity, shown as lower cavity 114, and a second cavity, shown as upper cavity 116. According to an exemplary embodiment, the upper cavity 116 is configured to receive at least one of planting media and at least a portion of the overhead arch support structure 160 (e.g., an end thereof, and the like). In some embodiments, the lower cavity 114 is configured to remain empty. In other embodiments, the lower cavity 114 is configured to receive a layer of rocks, large stones, and/or thick stoneware. In still other embodiments, the lower cavity 114 is configured to receive a thermal regulation system (e.g., to facilitate thermally regulating a temperature of the planting media, and the like), an irrigation system (e.g., to facilitate watering the plants within the planting media, and the like), an internal animal barrier (e.g., mesh grid, metal grid, rocks, etc.), and/or another type of device that may be used with the raised bed garden assembly 100.

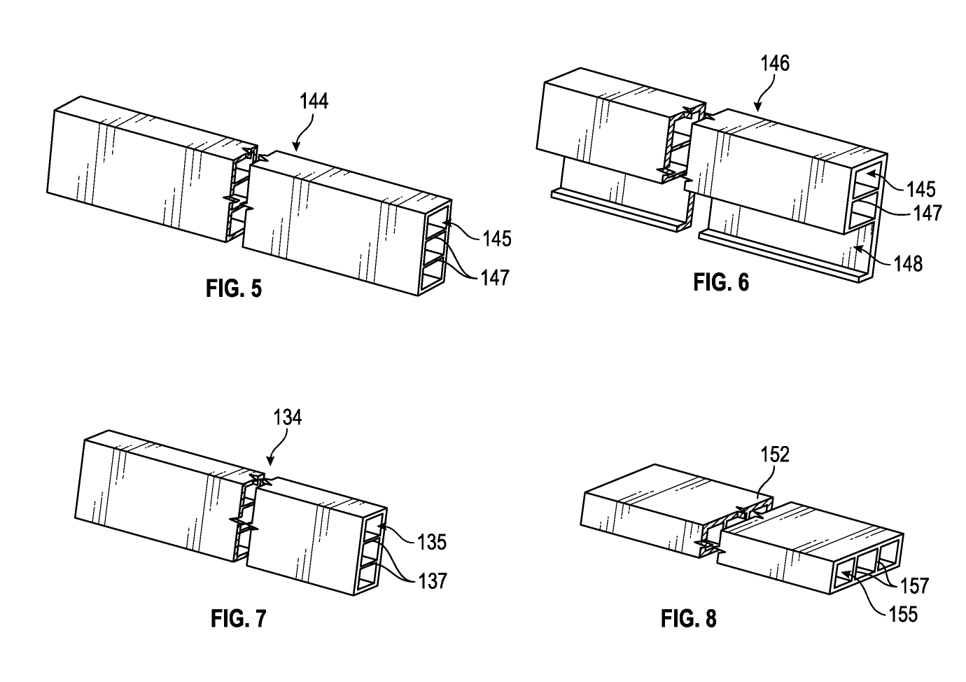

As shown in FIG. 4, the first sidewall 140 and the second sidewall 142 each include a plurality of side boards, shown as side boards 144, and a notched side board, shown as notched side board 146, defining the shelf slot 148 and disposed between the side boards 144. In other embodiments, the first sidewall 140 and/or the second sidewall 142 are a single, continuous panel. As shown in FIGS. 5 and 6, each of the side boards 144 and the notched side boards 146 has an at least partially hollow body such that each of the side boards 144 and the notched side boards 146 defines an internal chamber, shown as interior chamber 145. The interior chamber 145 of the side boards 144 and the notched side boards 146 may include a plurality of supports, shown as ribs 147, that extend longitudinally along the interior chamber 145 to provide support to the side boards 144 and the notched side boards 146.

As shown in FIG. 4, the first end wall 130 and the second end wall 132 each include a plurality of end boards, shown as end boards 134. In other embodiments, the first end wall 130 and/or the second end wall 132 are a single, continuous panel. As shown in FIG. 7, each of the end boards 134 has an at least partially hollow body such that each of the end boards 134 defines an internal chamber, shown as interior chamber 135. The interior chamber 135 of the end boards 134 may include a plurality of supports, shown as ribs 137, that extend longitudinally along the interior chamber 135 to provide support to the end boards 134.

As shown in FIG. 4, the support shelf 150 includes a plurality of lateral boards, shown as lateral boards 152. In other embodiments, the support shelf 150 is a single, continuous panel. As shown in FIG. 8, each of the lateral boards 152 has an at least partially hollow body such that each of the lateral boards 152 defines an internal chamber, shown as interior chamber 155. The interior chamber 155 of the lateral boards 152 may include a plurality of supports, shown as ribs 157, that extend longitudinally along the interior chamber 155 to provide support to the lateral boards 152.

According to an exemplary embodiment, the corner posts 120, the end boards 134, the side boards 144, the notched side boards 146, and/or the lateral boards 152 are manufactured from a lightweight, thin-walled, polymer material (e.g., plastic, polyvinyl chloride (“PVC”), and the like), which may provide improved time related deterioration relative to other materials. In other embodiments, the corner posts 120, the end boards 134, the side boards 144, the notched side boards 146, and/or the lateral boards 152 are manufactured from another material. By way of example, the corner posts 120, the end boards 134, the side boards 144, the notched side boards 146, and/or the lateral boards 152 may be manufactured from wooden landscape timbers, solid polymer lumber, mineral composite boards, MgO boards, cinder blocks, architectural blocks, a ceramic material, a metallic material, and/or any other material that has the flexural strength to withstand the lateral outward forces of a waist high bed of wet or dry planting media.

According to an exemplary embodiment, the corner posts 120 provide a tongue and grove fitment with the end boards 134, the side boards 144, and the notched side boards 146 such that the waist high planter box 110 may be assembled as a multi-layer box which is adhesively secured together without the use of mechanical fasteners. In alternative embodiments, the waist high planter box 110 additionally or alternatively includes mechanical fasteners. By way of example, a first layer of the of the multi-layer box including a first side board 144, a first end board 134, a second side board 144, and a second end board 134 may be slidably received within the first channels 124 and the second channels 128 of the corner posts 120 sequentially (as described above) and secured with adhesive to form the first layer and the shape of the waist high planter box 110. Thereafter, additional layers including a first side board 144, a first end board 134, a second side board 144, and a second end board 134 of the multi-layer box may be slidably received within the first channels 124 and the second channels 128 of the corner posts 120 sequentially and secured with adhesive to form additional layers of the multi-layer box. When the target height for the support shelf 150 is reached, the lateral boards 152 are inserted with the notched side boards 146 and adhesively secured to the other components of the multi-layer box. Again, additional layers including a first side board 144, a first end board 134, a second side board 144, and a second end board 134 of the multi-layer box may be slidably received within the first channels 124 and the second channels 128 of the corner posts 120 sequentially and secured with adhesive to form the remaining layers of the multi-layer box (e.g., until the waist high planter box 110 is waist high, etc.).

Once the desired height for the waist high planter box 110 is achieved, the end caps 190 may be positioned over the ends of the corner posts 120 to enclose the open end of the first channels 124 and the second channels 128 of the corner posts 120. As shown in FIG. 3, the waist high planter boxes 110 have a desired or predetermined height C. According to an exemplary embodiment, the desired height C is approximately waist high on an average sized adult male. In some embodiments, the desired height C is between 24 inches and 48 inches. In some embodiments, the desired height C is between 24 inches and 36 inches feet (e.g., 24, 26, 28, 30, 32, 34, 36, etc. inches). In some embodiments, the waist high planter box 110 has a width no greater 48 inches (1.22 meters) wide, allowing a person standing at a sidewall to easily reach the center of the waist high planter box 110 from any either side. In other embodiments, the width of the waist high planter box 110 is greater than 48 inches (e.g., 52, 56, 60, etc. inches).

As shown in FIG. 2, the internal cavity 112 of the waist high planter box 110 is configured to receive a planting media 180 (e.g., soil and the like). According to an exemplary embodiment, the planting media 180 provides varying levels of lateral forces on the first end wall 130, the second end wall 132, the first sidewall 140, and the second sidewall 142 (e.g., based on the volume of the planting media 180, the amount of moisture within the planting media 180, and the like). The lateral forces from the planting media 180 may be calculated from empirical formulae and that, with certain conditions, such as when the planting media 180 is very wet, the lateral forces generated thereby are relatively high. This is because a wet planting media 180 takes on the properties of a viscous fluid, and pushes in all directions. Thus, “creep” (i.e., sidewall distortion over time) is an important design consideration for commercial success.

According to an exemplary embodiment, the waist high planter box 110 is configured to accommodate for the lateral forces of the planting media 180 to prevent or minimize such creep. In some embodiments, the width and/or the length of the waist high planter box 110 is limited to the extent that the inherent flexural modulus of the boards satisfactorily retain the later forces of creep. According to an exemplary embodiment, the support shelf 150 provides planar reinforcement for the opposing sidewalls of the waist high planter box 110, while at the same time minimizes the amount of the planting media 180 necessary to fill the internal cavity 112 (i.e., only the upper cavity 116), which in turn, minimizes lateral forces from the planting media 180 (e.g., with the external aesthetics of the waist high planter box 110 remaining unchanged; since the planting media 118 rests on the support shelf 150, much less of it is needed to effectively fill the waist high planter box 110; etc.). The planar reinforcement of the support shelf 150 mitigates lateral, outward distortion of the waist high planter box 110, allowing a significantly wider box to be successfully assembled, without deteriorating the useful lifetime of the waist high planter box 110 (e.g., at least ten years, and the like). This means less lateral or gravitational stress from the weight of wet or dry planting media 180, which translates into less distortion or creep, and then to a longer garden life. It also means that less planting media 180 will have to be trucked, carried, and/or shoveled into the waist high planter box 110.

The support shelf 150 may additionally provide sufficient support such that the length of the waist high planter box 110 may be increased as much as space will permit. Since the lateral forces of any segment of waist high planter box 110 is supported by support shelf 150, numerous segments can be assembled serially, end to end. As shown in FIG. 10, the waist high planter box 110 may additionally include an intermediate post, shown as extension post 200. The extension post 200 includes a first portion, shown as first flange 202, defining a first open-ended channel, shown as first channel 204, and a second portion, shown as second flange 206, defining a second open-ended channel, shown as second channel 208, positioned at an angle θ of 180 degrees relative to the first channel 204. By way of example, the waist high planter box 110 may include two or more first sidewalls 140 and two or more second sidewalls 142. A first extension post 200 may be positioned between adjacent first sidewalls 140 such that the first channel 204 receives an end of one of the first sidewalls 140 and the second channel 208 receives an end of the other of the first sidewalls 140, thereby connecting the first sidewalls 140 together. A second extension post 200 may be positioned between adjacent second sidewalls 142 such that the first channel 204 receives an end of one of the second sidewalls 142 and the second channel 208 receives an end of the other of the second sidewalls 142, thereby connecting the second sidewalls 142 together.

The waist high planter box 110 may provide various advantages relative to non-waist high planter boxes. By way of example, the waist high planter box 110 prevents a gardener from having to bend, stoop down, or kneel while working in a garden including the waist high planter box 110. Less physical exertion may make gardening more enjoyable and efficient. By way of another example, the waist high planter box 110 facilitates people in wheelchairs working in a garden that includes the waist high planter box 110. By way of still another example, the waist high planter box 110 may minimize the growth of weeds because most weeds are blown along the ground into a garden bed such that a waist high bed will keep most of these weeds out of the garden. By way of yet another example, the waist high planter box 110 may keep many pests, such as rabbits, gophers, dogs, possums, raccoons, skunks, and the like, out of the garden because they cannot climb the steep, waist high sidewalls or enter through the bottom because of the support shelf 150.

### Overhead Arch Support Structure

According to an exemplary embodiment, the overhead arch support structure 160 provides the most efficient and productive form of vertical gardening because the overhead arch support structure 160 maximizes vertical space and brings produce within reach along the entire surface area thereof. Optimization of the overhead arch support structure 160 may include a particular ratio of key dimensions and a proper flexural modulus of the material thereof. The key dimensions may include a longitudinal length of the overhead arch support structure 160, a width of a base of the overhead arch support structure 160, and/or a height of at least one end of the overhead arch support structure 160 raised above the ground to effectuate a stable, parabolic arch with a desirable apogee height.

As shown in FIGS. 2 and 3, the overhead arch support structure 160 includes one or more wire grid panels, shown as wire grid panels 162. The wire grid panels 162 have a first end, shown as first end 164, and an opposing second end, shown as second end 166. The wire grid panels 162 have a target length that facilitates extending the wire grid panels 162 from a first waist high planter box 110 to a second waist high planter box 110 spaced a target distance from the first waist high planter box 110 in an arch shape. According to an exemplary embodiment, the target length of the wire grid panels 162 that form the overhead arch support structure 160 is about 16 feet (4.88 meters). In other embodiments, the target length of the wire grid panels 162 is greater than or less than about 16 feet. In some embodiments, the target length of the wire grid panels 162 is about 10 feet, or about 11 feet, or about 12 feet, or about 13 feet, or about 14 feet, or about 15 feet, or about 16 feet, or about 17 feet, or about 18 feet, or about 19 feet, or about 20 feet. In one embodiment, the target length of the wire grid panels 162 is 14.66 feet. It should be noted that an overly long commercially available wire grid panel 162 may be easily be cut to the proper length at an assembly site. A length of the wire grid panels 162 that is too long or too short may affect the apogee, shape, and sturdiness of the overhead arch support structure 160. Certain dimensional ratios of the overhead arch support structure 160, the waist high planter boxes 110, and the raised bed garden assembly 100 may be used to optimize the apogee, shape, and sturdiness of the overhead arch support structure 160, which is described in more detail herein.

As shown in FIG. 2, the first ends 164 of the wire grid panels 162 are disposed within the internal cavity 112 of the first waist high planter box 110 and buried within the planting media 180 disposed therein (e.g., in a furrow formed with the planting media 180, between 4 inches and 12 inches deep, etc.). The second ends 166 of the wire grid panels 162 are disposed within the internal cavity 112 of the second waist high planter box 110 and buried within the planting media 180 disposed therein (e.g., in a furrow formed with the planting media 180, between 4 inches and 12 inches deep, etc.). According to an exemplary embodiment, the first ends 164 and the second ends 166 of the wire grid panels 162 do not require any additional anchoring or fastening other than disposing the ends within the planting media 180. The entire assembly of the raised bed garden assembly 100 may thereby use no fasteners of any kind, and may be built by one person, with no need for special tools.

According to an exemplary embodiment, the wire grid panels 162 are manufactured as a perforate grid of steel. By way of example, the wire grid panels 162 may be manufactured from galvanized, heavy gauge steel wire that is spot welded where perpendicularly oriented wires intersect. In other embodiments, the wire grid panels 162 are manufactured from another material and/or otherwise constructed. According to an exemplary embodiment, the use of an arch creates a substantially robust overhead arch support structure 160. In this regard, testing demonstrates that the overhead arch support structure 160 can indefinitely support a static weight of at least about 160 pounds without collapsing. Such a weight represents at least three times the weight of a completely vegetated arch, loaded with produce of most or all varieties. The wire grid panels 162 are capable of such a high load rating not only due to the arch shape, but also because of the modulus of elasticity (Hook's Law) that allows continuous sustainment of the arch shape of the overhead arch support structure 160, without plastic deformation. According to an exemplary embodiment, the characteristics of the wire grid panels 162 of the overhead arch support structure 160 provide a sturdy support structure for vegetation that is resistant to side to side oscillations, with a modulus of elasticity such that overhead arch support structure 160 returns to its original shape after external forces applied to it are removed. Such oscillations are represented in FIG. 3 by panel shape changes 162A and 162B. After each oscillation caused by an outside force (e.g., wind, earthquake, and the like), the overhead arch support structure 160 returns to its original centered position.

### Assembly of Raised Bed Garden

As shown in FIG. 3, after assembling the waist high planter boxes 110 as described above, the waist high planter boxes 110 may be placed at a desired location such that the waist high planter boxes 110 are spaced a target distance E apart and define a pathway, shown as walkway 170, therebetween. According to an exemplary embodiment, the target distance E between the waist high planter boxes 110 is about 48 inches (about 1.22 meters). In other embodiments, the target distance E is greater than or less than about 48 inches. In some embodiments, the target distance E is about 40 inches, or about 41 inches, or about 42 inches, or about 43 inches, or about 44 inches, or about 45 inches, or about 46 inches, or about 47 inches, or about 49 inches, or about 50 inches, or about 51 inches, or about 52 inches, based on user preference. Following placement of the waist high planter boxes 110, the internal cavities 112 (e.g., the upper cavities 116, etc.) may be filled with the planting media 180.

After the waist high planter boxes 110 have been prepared with the planting media 180, the assembly process is completed by placing the first end 164 of the wire grid panel 162 in the planting media 180 one of the waist high planter boxes 110, thereby anchoring that end sufficiently within the planting media 180. It is to be appreciated that such assembly does not require the use of fasteners, welding, adhesives, or joining of any kind, or the like). The second end 166 of the wire grid panel 162 may then be maneuvered, flexed, and placed into the planting media 180 of the other of the waist high planter boxes 110, thereby anchoring the loose end sufficiently within the planting media 180 and forming the overhead arch support structure 160 (e.g., without the use of fasteners, welding, or joining of any kind, and the like). Thereafter, the internal cavities 112 may be filled with excess planting media 180. The overhead arch support structure 160 may now be held in a dynamic equilibrium of forces, making the overhead arch support structure 160 stable and resistant to side to side oscillations. According to an exemplary embodiment, the support shelf 150 of the first waist high planter box 110 and the second waist high planter box 110 elevates the first end 164 and the second end 166 of the wire grid panel 162, respectively, the target height above the ground surface.

As shown in FIG. 3, the first end 164 of the wire grid panel 162 is spaced a target distance D from the inner sidewall of a first waist high planter box 110 and the second end 166 of the wire grid panel 162 is spaced the target distance D from the inner sidewall of a second waist high planter box 110. According to an exemplary embodiment, the target distance D (i) between the inner sidewall of the first waist high planter box 110 and the first end 164 of the wire grid panel 162 and (ii) between the inner sidewall of the second waist high planter box 110 and the second end 166 of the wire grid panel 162 is defined by the following empirical formula:

2D+E=0.4L (1)

where D is the target distance between an end of the wire grid panel 162 and an inner sidewall of an associated waist high planter box 110, L is the longitudinal length of wire grid panel 162, and E is the width of the walkway 170. Therefore, using Equation (1) the target distance D may be determined. By way of example, with a walkway 170 having a width of 48 inches and a wire grid panel 162 having a length of 16 feet (192 inches), the target distance D is 14.4 inches from the inner sidewall of each waist high planter box 110. Therefore, if a 16 foot wire grid panel 162 is desired to be used without cutting its length, Equation (1) may be used to determine the best width E to achieve this result. Alternatively, if space is restricted and the walkway 170 must be narrowed, Equation (1) could be used to determine the best length to cut the wire grid panel 162 to.

Further, the base A of the overhead arch support structure 160 may be increased in two ways, namely by increasing width E of the walkway 170 and/or by increasing the distance D between the inside sidewall of the waist high planter boxes 110 and the ends of the wire gird panel 162. As would be understood by one of ordinary skill in the art, as the base A of the overhead arch support structure 160 increases, a height or apogee B of the overhead arch support structure 160 decreases, and vice versa. According to an exemplary embodiment, the length L of the wire grid panel 162, the target distance E between the first waist high planter box 110 and the second waist high planter box 110, the target distance D, and/or the target height of the support shelf 150 provides the apogee B of the overhead arch support structure 160 that is between 6 and 8 feet tall. In one embodiment, a desirable apogee B of the overhead arch support structure 160 is approximately 7 feet where the overhead arch support structure 160 can be optimally reached overhead by an adult gardener.

According to an exemplary embodiment, the dimensions of the raised bed garden assembly 100 allows a person to walk between the waist high planter boxes 110 along the walkway 170 underneath the overhead arch support structure 160 at the optimum height for total access to the produce everywhere along the overhead arch support structure 160. In contrast to the vertical planar support structure 54 of FIG. 1C, the vertical planar support structure 54 is limited to the height a person can reach vertically upward, along only one vertical plane, when standing on the ground. In the embodiment shown in FIG. 3, the overhead arch support structure 160 rises up and then curves toward the person, making the plants and vegetables to be tied or harvested, always within reach of a person standing anywhere in the walkway 170.

Given the desirability to produce an apogee B that a standing person can work under, and have vegetation that is arms-reach high, the waist high anchoring platform provided by the waist high planter boxes 110 is ideal to maintain stability and load bearing capability with such a high apogee B. Conversely, if the wire grid panel 162 were to arise directly from the ground with a similar height apogee B, the parabolic arch shape and properties would be compromised, leading to diminished load bearing capability and less stability. The top segment of the arch would be less stable and the back and forth oscillations would have greater displacement. Further, if the arch shape and resulting desired properties were restored by shortening the length of the wire grid panel 162, the apogee B measured from the ground level would then be too low to comfortably work and walk under.

According to an exemplary embodiment, the raised bed garden assembly 100 is configured to be enlarged in a modular fashion. By way of example, the raised bed garden assembly 100 may be modularly enlarged in a serial and/or a parallel fashion. For example, three or more waist high planter boxes 110 may be arranged side-by-side (i.e., in parallel), with a pathway between each waist high planter box 110. This can be done after the two box initial garden assembly is completed, at any convenient time. After a new waist high planter box 110 is assembled, a second overhead arch support structure 160 can be placed in an existing box and arched over to the newly added box. As another example, the length of a waist high planter box 110 within the raised bed garden assembly 100 may be expanded using the extension posts 200 to connect two or more waist high planter boxes 110 in series.

From the description above, a number of advantages of some embodiments of the raised bed garden assembly 100 become evident. In particular, with a waist high or other predetermined level in accordance with the teachings of the present disclosure (i) all garden work can be done at waist high or other predetermined level and/or over one's head on the upwardly arched wire grid panels such that no bending or stooping is necessary, and accordingly, persons of any age, stature, or height can maintain a productive garden; (ii) roots can grow long and deep yielding a healthy and productive garden; (iii) vegetable vines grow up onto the wire arch, increasing the effective growing area up to 500% over the horizontal bed space of raised beds (e.g., the overhead arch support structure 160 increases a 1 sq. foot horizontal bed area to at least 5 sq. feet of growable area on the wire grid panel 162, etc.) and up to 250% over a raised bed with a vertical support structure; (iv) no cemented, or otherwise anchored, reinforcing vertical posts for sidewall support are needed, (v) wind-blown weed seeds cannot easily get into the waist high garden, so weeding is kept to a minimum.; (vi) box assembly of glued thin-walled, lightweight polymer components requires no mechanical fasteners and is easy and quick using the uniquely designed tongue and groove corner post; (vii) specially designed polymer sideboards allow use of a planar reinforcement system that mitigates sidewall distortion, without changing the outer aesthetics of the garden boxes; (viii) a layer of large stones at the very bottom of the planter bed can eliminate intrusion by gophers, and still leave a deep bed for enhanced root growth; (ix) a sturdy, waist high garden can be assembled by one person with minimal or no tools and modest skills, using readily available and economical materials, or a provided kit; and/or (x) the waist high planter boxes resist deformation for an indefinite period of time, making all of the above benefits possible.

### Additional Embodiments

According to the exemplary embodiment shown in FIG. 11, a garden assembly, shown as raised bed garden assembly 300, includes a single waist high planter box 110 with a support structure, shown vertical support structure 310, extending from the planting media 180 disposed therein. As shown in FIG. 11, the vertical support structure 310 includes a pair of wire grid panels 162 that form a triangle shape. In other embodiments, the raised bed garden assembly 300 does not include the vertical support structure 310. In still other embodiments, the raised bed garden assembly 300 includes a single wire grid panel 162 that extends from the waist high planter box 110 and is anchored to the ground or a wall surface, forming an arch or curved shape.

It is important to note that the construction and arrangement of the elements of the systems, methods, and apparatuses as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations.

Embodiments have been described in connection with the accompanying drawings. However, it should be understood that the figures are not drawn to scale. Distances, angles, shapes, etc. are merely illustrative and do not necessarily bear an exact relationship to actual dimensions and layout of the articles that are illustrated. In addition, the foregoing embodiments have been described at a level of detail to allow one of ordinary skill in the art to make and use the articles, parts, different materials, etc. described herein. A wide variety of variation is possible. Articles, materials, elements, and/or steps can be altered, added, removed, or rearranged. While certain embodiments have been explicitly described, other embodiments will become apparent to those of ordinary skill in the art based on this disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or configurations are in any way required for one or more embodiments. The terms “comprising,” “including,” “having,” and the like are synonymous and are used inclusively, in an open-ended fashion, and do not exclude additional elements, features, acts, operations, and so forth. The term “consisting essentially of” can be used anywhere where the terms comprising, including, containing or having are used herein, but consistent essentially of is intended to mean that the claim scope covers or is limited to the specified materials or steps recited and those that do not materially affect the basic and novel characteristic(s) of the claimed invention. Also, the term “consisting of” can be used anywhere where the terms comprising, including, containing or having are used herein, but consistent of excludes any element, step, or ingredient not specified in a given claim where it is used.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

Additionally, in the subject description, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A raised bed planter box, comprising:
a plurality of corner posts including a first corner post, a second corner post, a third corner post, and a fourth corner post, each of the plurality of corner posts defining a first open-ended channel and a second open-ended channel positioned at an angle of about 90 degrees relative to the first open-ended channel;
a first sidewall extending between the first open-ended channel of the first corner post and the first open-ended channel of the second corner post;
a first end wall extending between the second open-ended channel of the second corner post and the second open-ended channel of the third corner post;
a second sidewall extending between the first open-ended channel of the third corner post and the first open-ended channel of the fourth corner post; and
a second end wall extending between the second open-ended channel of the fourth corner post and the second open-ended channel of the first corner post;
wherein the first sidewall, the second sidewall, the first end wall, and the second end wall cooperatively define an internal cavity of the raised bed planter box.

2. The raised bed planter box of claim 1, wherein the first sidewall defines a first slot that extends along a longitudinal length thereof and the second sidewall defines a second slot that extends along a longitudinal length thereof.

3. The raised bed planter box of claim 2, wherein the first sidewall and the second sidewall include a plurality of side boards.

4. The raised bed planter box of claim 3, wherein the plurality of sideboards of the first sidewall includes a first notched side board defining the first slot and the plurality of sideboards of the second sidewall includes a second notched side board defining the second slot.

5. The raised bed planter box of claim 2, further comprising a shelf received by the first slot and the second slot such that the shelf extends laterally between the first sidewall and the second sidewall separating the internal cavity into an upper cavity and a lower cavity.

6. The raised bed planter box of claim 5, wherein the shelf includes a plurality of lateral boards.

7. The raised bed planter box of claim 5, wherein the upper cavity is configured to receive at least one of planting media and at least a portion of a plant support structure.

8. The raised bed planter box of claim 1, wherein the first end wall and the second end wall include a plurality of end boards.

9. The raised bed planter box of claim 1, wherein the plurality of corner posts, the first sidewall, the second sidewall, the first end wall, and the second end wall are a thin-walled plastic material.

10. The raised bed planter box of claim 1, wherein the first sidewall, the second sidewall, the first end wall, and the second end wall are at least partially hollow.

11. The raised bed planter box of claim 1, wherein the plurality of corner posts, the first sidewall, the second sidewall, the first end wall, and the second end wall are secured together with an adhesive.

12. The raised bed planter box of claim 1, further comprising a first intermediate post and a second intermediate post, each of the first intermediate post and the second intermediate post defining a third open-ended channel and a fourth open-ended channel positioned at an angle of 180 degrees relative to the third open-ended channel, wherein the first sidewall includes a first pair of sidewalls and the second sidewall includes a second pair of sidewalls, and wherein the first intermediate post is positioned between the first pair of sidewalls and the second intermediate post is positioned between the second pair of sidewalls.

13. A raised bed garden assembly, comprising:
a first planter box having a predetermined height;
a second planter box having the predetermined height and spaced at a predetermined distance from the first planter box; and
a wire grid panel having a length that extends between the first planter box and the second planter box to form an overhead arch support structure;
wherein each of the first planter box and the second planter box includes:
a first end wall;
a second end wall;
a first sidewall defining a first slot at a target height above a ground surface;
a second sidewall defining a second slot at the target height above the ground surface, wherein the first end wall, the second end wall, the first sidewall, and the second sidewall cooperatively define an internal cavity; and
a support shelf disposed within the internal cavity and received by the first slot and the second slot such that the support shelf extends laterally between the first sidewall and the second sidewall.

14. The raised bed garden assembly of claim 13, wherein the wire grid panel includes a first end disposed within the first planter box and an opposing second end disposed within the second planter box, and wherein the first planter box and the second planter box elevate the first end and the second end of the wire grid panel, respectively, above the ground surface.

15. The raised bed garden assembly of claim 14, wherein the length of the wire grid panel, the predetermined distance between the first planter box and the second planter box, and the predetermined height of the first planter box and the second planter box provides an apogee of the overhead arch support structure that is between about 6 feet tall and 8 about feet tall.

16. The raised bed garden assembly of claim 14, further comprising a plurality of corner posts positioned to couple the first end wall, the second end wall, the first sidewall, and the second sidewall together, wherein each of the plurality of corner posts defines a first open-ended channel and a second open-ended channel positioned at an angle of about 90 degrees relative to the first open-ended channel.

17. A raised bed planter box, comprising:
a first end wall;
a second end wall;
a first sidewall defining a first recess at a predetermined height above a ground surface;
a second sidewall defining a second recess at the predetermined height above the ground surface;
a plurality of corner posts configured to couple the first end wall, the second end wall, the first sidewall, and the second sidewall together such that the first end wall, the second end wall, the first sidewall, and the second sidewall cooperatively define an internal cavity; and
a support shelf configured to be disposed within the internal cavity and received by the first recess and the second recess such that the support shelf extends laterally between the first sidewall and the second sidewall at the predetermined height and separates the internal cavity into an upper cavity and a lower cavity.

18. The raised bed planter box of claim 17, wherein at least one of:
the plurality of corner posts, the first sidewall, the second sidewall, the first end wall, the second end wall, and the support shelf are a thin-walled plastic material;
the first sidewall, the second sidewall, the first end wall, the second end wall, and the support shelf are at least partially hollow; and
the plurality of corner posts, the first sidewall, the second sidewall, the first end wall, the second end wall, and the support shelf are secured together with an adhesive.

19. The raised bed planter box of claim 17, wherein:
the first end wall and the second end wall include a plurality of end boards;
the first sidewall and the second sidewall include a plurality of side boards, the plurality of sideboards of the first sidewall including a first notched side board defining the first recess, and the plurality of sideboards of the second sidewall including a second notched side board defining the second recess; and
the support shelf includes a plurality of lateral boards.

20. The raised bed planter box of claim 17, wherein each of the plurality of corner posts defines a first channel and a second channel positioned at an angle of about 90 degrees relative to the first channel.
